(19) United States
(12) Patent Application Publication
(10) Pub. No.: US 2010/0184560 A1
(43) Pub. Date: Jul. 22, 2010

(54) LONG RANGE ELECTRIC VEHICLE

(76) Inventor: Glen L. Campbell, Littleton, CO (US)

Correspondence Address: SHERIDAN ROSS PC, 1560 BROADWAY, SUITE 1200, DENVER, CO, 80202, US

(21) Appl. No.: 12/689,140

(22) Filed: Jan. 18, 2010

Related U.S. Application Data
(60) Provisional application No. 61/166,456, filed on Apr. 3, 2009.
(60) Provisional application No. 61/145,414, filed on Jan. 16, 2009.

(51) Int. Cl. B60W 10/08; H02P 27/00; B60K 1/04; B60W 30/18

(52) U.S. Cl. 477/7; 318/139; 180/65.31

(57) ABSTRACT

A long range electric vehicle includes means for switching between a charge depleted power source to a charged power source to extend its travel distance. The electric vehicle carries two battery banks, each bank formed from a plurality of batteries. Current from the batteries is delivered to a motor via a motor controller.

### CROSS REFERENCE TO RELATED APPLICATIONS

This Application claims the benefit of U.S. Provisional Application Nos. 61/145,414, filed Jan. 16, 2009, and 61/166,456, filed Apr. 3, 2009, the entire disclosures of which are hereby incorporated herein by reference.

### FIELD OF THE INVENTION

The present invention is generally related to automobiles and more specifically to a long-range electric automobile and methods of operating the same.

### BACKGROUND OF THE INVENTION

The basic propulsion system of an electric vehicle consists of three main parts: an electric motor, a motor controller and a battery. When the accelerator pedal is pushed on an electric vehicle, the controller delivers electrical current from the battery to the motor, accelerating the vehicle. When the vehicle is idle, the energy stored in the batteries is not used since the electrical current is not being processed. This basic operation of an electric vehicle continues to be of interest since it is environmentally friendly compared to gasoline powered vehicles and it offers a reduction in pollutants emitted by the vehicle.

Even with this benefit, electric vehicles have had limited success due to two main issues, the limits on driving distance and the lack of power. The first concern is attributed to the batteries and their limited capacity to provide long driving distances of the vehicle. The current battery technologies being used in electric vehicles limits the distance traveled before needing a recharge. This is a major limitation of electric vehicles since more miles than that are typically traveled in a round trip by individuals. Recharging stations must be strategically placed within driving range of the vehicle and it can take up to 8-10 hours to charge an electric vehicle in a standard outlet. Recharging of the batteries typically takes place via a mechanical electrical connection or through inductive coupling of magnetic fields at a dedicated recharging station. Due to the amount of time it takes to recharge an electric vehicle and the limited driving distance, it would be desirable to use the power that batteries provide more efficiently and increase the overall distance that the electric vehicle can travel before needing a recharge.

The second issue with electric vehicles has been the lack of power, specifically for quick acceleration of the vehicle. In order to provide the short “bursts” of electric energy that can help electric vehicles accelerate at comparable or better rates than gasoline powered vehicles, switchable configurations of battery banks could be used. This configuration would add excess weight to the vehicle and complexity to the overall electronic circuitry. It would be beneficial to have a lightweight supplemental power source to help supply the needed additional power needed during peak consumption periods, like vehicle acceleration. Therefore, what is needed is a system that can power environmentally friendly electric vehicles with an increased travel distance and with the same acceleration as expected from that of gasoline powered vehicles.

### SUMMARY OF THE INVENTION

The purpose of the present invention is to provide a long range electric powered vehicle. Another purpose of the present invention is to provide a supplementary power source to the electric motor in times of high current demand, such as accelerating the vehicle. Generally, the electric vehicle is powered by one or more sets of battery banks connected to an electric motor in series. The electric current is controlled and distributed through a system from the battery banks to the electric motor. The battery banks are formed by a plurality of batteries connected in series and each bank has a positive and negative terminal to deliver the available current to the electric motor. Voltage and current being delivered to the electric motor from the battery banks is monitored and if the one or both of these levels falls below a predetermined level, the current draw may be switched from the charge depleted battery bank to the backup bank (likely a fully charged battery bank). If the electric motor demands more current than what the battery banks are able to deliver for a short amount time, a capacitor bank is available to assist as a supplementary power source to the electric motor. This is particularly beneficial during times of vehicle acceleration where the current draw from the motor is highly elevated.

The ability to switch between a charge depleted battery bank and a fully charged battery bank helps to overcome the current issue of electric vehicles typically traveling less than 100 miles. By having two or more battery banks onboard the electric vehicle, a car assembled in accordance with at least some embodiments of the present invention will be adapted to travel between about 150 and 200 miles in the city or between about 350 and 600 miles on the highway on a single charge when both battery banks are fully charged. The inclusion of a capacitor bank helps to overcome the lack of power associated to electric vehicles during times of quick acceleration. The capacitor bank stores a charge delivered from the power source and releases it when the demand of the electric motor necessitates an increase in current to handle the load from the vehicles transmission. The integration of these two features into an electric vehicle permits the vehicle to become more long range in traveling distance and provides increased power to the vehicle during times of acceleration.

In accordance with at least some embodiments of the present invention a long range electric vehicle is provided that generally comprises:
a) first and second battery banks which are selectably connectable to a motor, each battery bank formed from a plurality of batteries, each battery bank having a positive and negative terminal comprising a power source with available current;
b) a capacitor bank comprising a supplementary power source;
c) a controller operable to selectively control power provided from at least one of the power sources or supplementary power source to an electric motor;
d) a monitoring mechanism operable to monitor an energy level of each of the battery banks and effect the controller to switch between power sources based on the monitored energy level of each of the battery banks;

The Summary is neither intended nor should it be construed as being representative of the full extent and scope of the present invention. The present invention is set forth in various levels of detail and the Summary as well as in the attached drawings and in the detailed description of the invention and no limitation as to the scope of the present invention is intended by either the inclusion or non inclusion of elements, components, etc. in the Summary. Additional aspects of the present invention will become more readily apparent from the detailed description, particularly when taken together with the drawings.

### BRIEF DESCRIPTION OF THE DRAWING FIGURES

In order to more fully understand the present invention, it can be described by way of example with reference to the following drawings in which:

FIG. 1 is an illustrative view of an electric vehicle;

FIG. 2 is an electrical schematic of the electrical system in accordance with embodiments of the present invention; and

FIG. 3 is a simplified electrical schematic of the power feedback system in accordance with embodiments of the present invention.

### DETAILED DESCRIPTION OF THE INVENTION

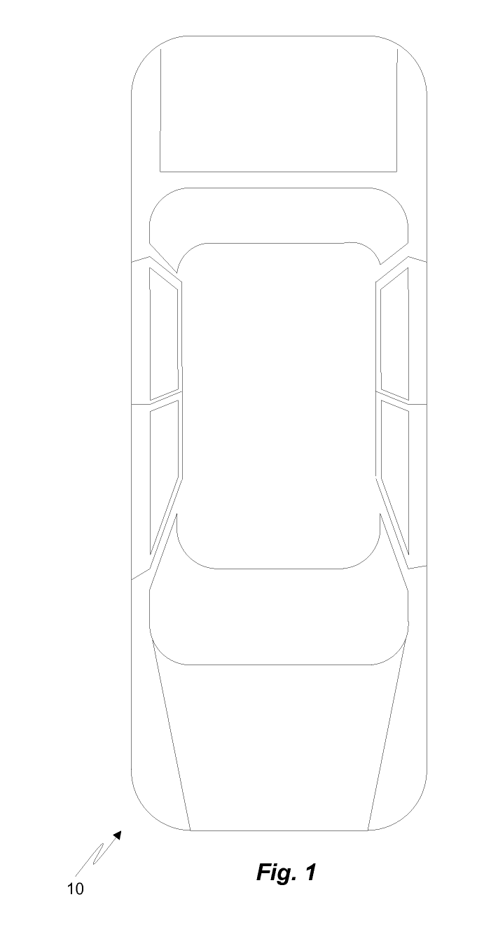

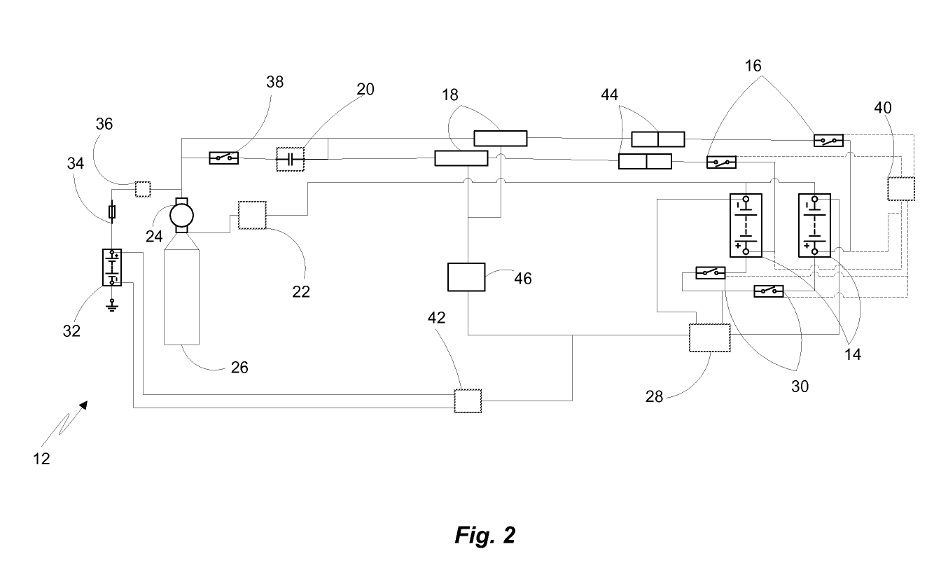

FIG. 1 illustrates an electric vehicle 10 that includes an electrical system 12 shown in FIG. 2. The electric vehicle could weigh anywhere between 3,000 lbs and 6,000 lbs. In accordance with embodiments of the present invention, the electrical system 12 depicted in FIG. 2 includes a power source 14, a pair of breakers 16 each connected to series of limit switches 18 and DC drive motors/alternator sets 44, a capacitor box 20 and a motor controller 22 all of which may be in electrical communication with an electric motor 24 that drives a transmission 26. In some embodiments, the capacitor box 20 is connected to a limiting switch 38, adapted to control/limit the amount of current provided to the motor 24. The electrical system 12 could be used in a variety of industrial and automotive applications, but this detailed description relates to an electric vehicle 10 wherein the transmission 26 is driven by an electric motor 24.

The power source 14 shown may comprise two or more individual power sources (e.g., 120V DC battery boxes, comprising an array of DC batteries), with a means of being charged by a 120V DC charger 28, such as a gas powered generator. In other embodiments, the power source 14 includes two or more individual power sources that include a series of battery boxes which create an equivalent 48 V DC source. In some embodiments, multiple DC battery packs can be series connected to create the 48 V DC source.

The power source 14 could also include any other electric energy producing or storage device. The array of batteries within the battery boxes are connected to one another to provide the necessary amperage needed by the electric motor 24 to power the load of or turn the transmission 26. In other embodiments, the power source 14 provides a sufficient amount of energy to drive the drive motor of the drive motor/alternator set 44. In some embodiments, each drive motor/alternator set 44 comprises a 20 HP/48 V DC drive motor configured to turn its corresponding alternator at about 1800 RPM. In some embodiments, each drive motor/alternator set 44 comprises a 20 HP/48 V DC drive motor configured to power multiple alternators, rated at approximately 230 V and 100 A, each. In this particular configuration, if two alternators are provided in each drive motor/alternator set 44, four total alternators are provided, and each drive motor/alternator set 44 supplies approximately 460 V to the electric motor 24. Accordingly, each power source in the DC power source 14 is used to operate a DC drive motor, which, in turn, operates one or more alternators. The alternators in the drive motor/alternator set 44 provide AC current to the electric motor 24, which powers the transmission 26.

In other embodiments, each 120V battery box contains a bank of ten 12V batteries that are wired in series and preferably weigh no more than 26 lbs each. With two 120V battery boxes contained on the electric vehicle 10, embodiments of the present invention may be adapted to utilize a total of 20 batteries as its power source 14. A variety of battery types (e.g. wet cell, lithium ion, spiral cell or absorbed glass mat) may be utilized as a power source 14 for the electric vehicle 10 but the preferred battery type is that of a sealed mat gel type. Mat gel batteries offer the benefit of dispensing their charge at a higher rate and if the battery container is cracked or breached, the battery will continue to function. Since mat gel batteries are sealed, they also provide the benefit of preventing an operator from coming in contact with the electrolyte within the battery and possibly being burned.

A charger 28 may be electrically connected to one or more power feedback sources to accomplish the charging of the power source 14. One source of power feedback may include an accessory battery 32 providing power to the various on-board electronic devices of the vehicle 10. Another source or sources of power feedback may include the drive motor/alternator sets 44, which are connected to the charger 28 via one or more current limiting switches 18 and/or a power transformer 46. In some embodiments, the current limiting switches 18 ensure that power is supplied to the drive motor 24 when needed. When the full capacity of the power source 14 supplied to the drive motor/alternator sets 44 is not needed, however, the current limiting switches 18 allow current to be provided to the power transformer 46, where the current is conditioned such that it can be received and processed by the charger 28. In some embodiments, the charger 28 comprises a 48 V battery charger and the transformer 46 is adapted to alter 240 V AC current to 48 V DC current, such that the charger 28 can properly operate and provide current back to the power source 14.

In some embodiments, an isolation switch 30 is located between each of the power sources 14 and the charger 28. The isolation switches 30 provide the ability to isolate which battery box of the power source 14 is charged at any given time. Each battery box containing a bank multiple batteries preferably provides the electric vehicle 10 the ability to travel up to 150 miles per bank of batteries. By using multiple and separate battery boxes as the power source 14 of the electric vehicle 10, the electric vehicle (e.g., non-hybrid vehicle) is adapted to travel between about 150 and about 600 miles per charge (or 6-10 hours per charge), depending upon the type of driving, the condition of the batteries, etc. Each bank of batteries preferably provides at least an available 8,500 amps to the electric vehicle 10 at all times. The bank of batteries contained in each battery box preferably possesses an instantaneous 9,250 amps per bank.

In accordance with at least some embodiments of the present invention, logic may be utilized to determine which power source 14 should be connected to the charger 28. As one example, the power source 14 not currently connected to the motor 24 may be connected to the charger 28, thereby allowing the non-active power source 14 to be charged while the other power source 14 acts as the active power source. In other embodiments, the active power source 14 may be charged while the non-active power source 14 is not charged.

The electric current of the power source 14 is coupled to the rest of the system when the breakers 16 are closed and separated from the rest of the system when the breakers 16 are opened. Electric current passes through the breakers 16 from the power source 14 when they are closed and continues to the drive motor/alternator sets 44 that switches the electric current to from a DC-type current to an AC-type current. At this point, current is allowed to pass to the drive motor 24 via the limiting switches 18, capacitor bank 20 and second limiting switch 38.

In some embodiments, the instantaneous 9,250 amps that each battery bank provides is used to power the electric motor 24 as it draws 250 amps during the periods of accelerating the electric vehicle 10. Once the electric vehicle 10 has accelerated to a desirable speed where the electric motor 24 output reaches 6,500 RPMS, the electric motor 24 draws preferably about 50 amps. Each battery box of the power source 14 is connected to its own set of breakers 16, 18 and in one embodiment electric current may be supplied by one battery box at a time. In another embodiment, electric current from both battery boxes of the power source 14 may be used in conjunction with one another simultaneously.

When one of the battery banks of the power source 14 reaches approximately 30% to 50% or less of its charge capacity, electric current may be drawn from the second fully charged battery bank. The charge capacity of each battery bank is monitored by the logic controller 40. The logic controller 40 ensures that enough charge capacity exists in the battery bank to provide the needed electrical current to power the electric motor 24. When the charge capacity diminishes below the needed level, the logic controller 40 informs the vehicle operator. The process of switching electric current draw from a depleted battery bank to a fully charged battery bank may either be a manual or an automatic switching process. In a manual switching process, the vehicle operator would first open the breaker 16 attached to the depleted battery bank. Then, the operator would close the breaker 16 attached to the fully charged battery bank to supply electric current from the power source 14 to the electric motor 24. In an automatic switching process, the logic controller 40 would first open the breaker 16 attached to the depleted battery bank and then close the breaker 16 attached to the fully charged battery bank. The ability to switch between a charge depleted battery bank and a fully charged battery bank provides the electric vehicle 10 with the ability to preferably travel 500 miles per charge.

As the main contactors 18 switch electric current flowing from the breakers 16 to the electric motor 24, the electric current may follow two paths. In the first path, the electric current passes through the contactor 18 and flows directly to the electric motor 24. In the second path, the electric current flows from the contactors 18 to a capacitor box 20 containing an array of capacitors. The parallel connection of the capacitor box 20 to the contactors 18 and electric motor 24 allows for electric current flowing from the contactors 18 to charge and develop an electrical potential within the capacitor box 20. The electrical discharge from the capacitor box 20 passes through a limit switch 38 to provide electric current to the electric motor 24. The opening and closing of the limit switch 38 is governed by the electric current demands from the electric motor 24. As the demand for electric current from the electric motor 24 increases beyond the electric current provided by the power source 14, the limit switch 38 is activated to discharge additional electric current from the capacitor box 20 to the motor 24. Limit switches with different amperage maximums and minimums may be used in such a system to regulate when additional electric current is discharged from the capacitor box 20 to the electric motor 24.

Electric current from the power source 14 is also coupled to an electric motor controller 22. The electric motor controller 22 regulates the amount of electric current distributed from the power source 14 to the electric motor 24. As the electric current demand on the electric motor 24 increases due to the load from the transmission 26 the electric motor controller 22 may increase or decrease the amount of electric current supplied to the electric motor 24. In increasing the amount of current provided to the electric motor 24 from the power source 14, the electric motor controller 22 potentially decreases the amount of power provided to the energy feedback system. If the amount of electric current supplied to the electric motor 24 through the electric motor controller 22 is less than the demand, then the limit switch 38 would close, allowing for discharge of the capacitor box 20. The discharge of the capacitor box 20 would supply the needed additional electric current to the electric motor 24 during times of increased load, such as accelerating the electric vehicle 10.

An accessory battery 32 may provide power to the accessory system (e.g., lights, displays, power steering, etc.) of the vehicle 10. The accessory system is protected from by electric current surges or electrical shorts within the system by the accessory fuse box 34. The means of charging the battery 32 is accomplished with the alternator 36, which may be rated at approximately 12 V if the accessory battery 32 comprises a 12 V battery. Preferably, the 12V DC battery 32 is capable of providing between 60 amps and 250 amps at any point during operation. If the power source 14 happens to fail or lose its charge, the 12V DC accessory battery 32 may be utilized to power the electric motor 24 and move the electric vehicle up to about 10 additional miles. The accessory battery 32 may also be connected to a power inverter 42 to supply electrical current to the charger 28 for the purpose of charging the battery box power source 14. Similar to the transformer 46, the power inverter 42 may condition the current provided from the accessory battery 32 such that it can be utilized by the charger 28 to re-charge the power source 14. This option of supplying additional charging capability to the power source 14 would provide power needed for the electric vehicle to travel additional miles. As an alternative to employing a single power inverter 42, multiple power inverters may be utilized. As can be appreciated by one skilled in the art, other inverter configurations may also be used.

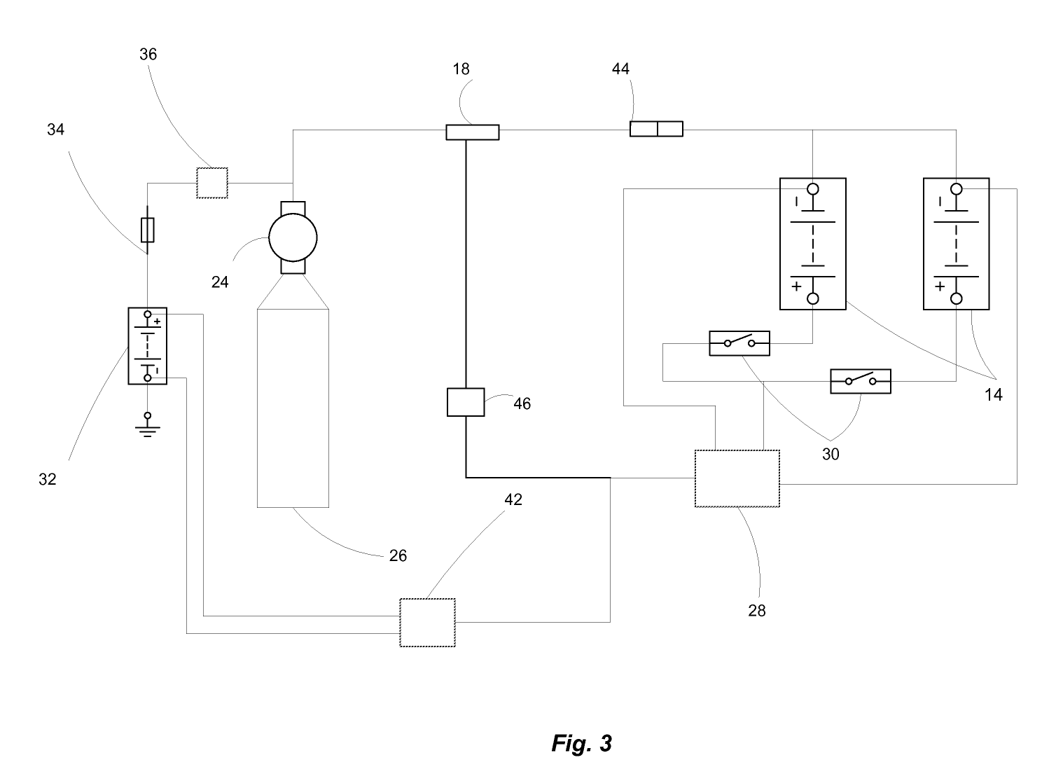

FIG. 3 is a simplified electrical schematic showing the accessory battery 32 connected to the charger 28 by means of a power inverter 42 as well as one of the drive motor/alternator sets 44 connected to the charger 28 via a limiting switch 18 and transformer 46. For simplicity, all of the devices in the electrical wire path from the negative terminal of the 120V DC battery box power source 14 to the motor shown in FIG. 2 have been removed and represented by one electrical wire. Also, for simplicity only, just one of the drive motor/alternator sets 44 and limiting switches 18 has been depicted in FIG. 3 to help clearly describe the power feedback mechanisms of the present invention.

In some embodiments, the accessory battery 32 may be connected to the battery box power source 14, by means of a power inverter 42. As the alternator 36 charges the accessory battery 32, electrical current can be routed to the power inverter 42, where typically DC current is converted to AC current (AC to DC conversion may also be possible in certain system configurations). The AC current is then directed to the DC charger 28, which can then charge the battery box power source 14.

As shown in FIGS. 2 and 3, the charger 28 has isolation switches 30 inline with the connection to the power source 14. These isolation switches 30 provide the ability to isolate which of the two battery boxes is charged within the power source 14 at any given time. As the DC current is converted to AC current at the power inverter 42 and directed to the charger 28, the logic controller 40 has the ability to open or close the isolation switches 30 depending on which battery bank of the power source 14 requires charging. As previously stated, the charge capacity of each battery bank is monitored by the logic controller 40 in order to provide the needed electrical current to power the electric motor 24.

As a non-limiting example, when one of the battery banks of the power source 14 reaches an approximate threshold of between about 30% and 50% of its charge capacity, electric current is drawn from the second fully charged battery bank as directed by the logic controller 40. First, the logic controller 40 would open the breaker 16 and close the isolation switch 30 attached to the depleted battery bank. The opening of the breaker 16 connected to the depleted battery bank removes the electrical current draw by the electric motor 24 from the depleted battery bank. The closing of the isolation switch 30 directs any current being delivered by the power inverter 42 to the 120V DC charger 28 to charge only the depleted battery bank. Second, the logic controller 40 would close the breaker 16 and open the isolation switch 30 attached to the fully charged battery bank. The closing of the breaker 16 connected to the fully charged battery bank provides the needed electrical current to power the electric motor 24 from the fully charged battery bank. The opening of the isolation switch 30 does not allow the current being delivered by the power inverter 42 to the 120V DC charger 28 to reach the fully charged battery bank.

As the fully charged battery bank is depleted of its electrical charge and reaches an approximate threshold of between 30% to 50% of its charge capacity, the logic controller 40 will direct electrical current to be drawn from the battery bank that was previously being charged by the 120V DC charger 28. The same process of switching from a depleted battery bank to a charged battery bank, as described above, is followed. However, the battery bank being charged in this case may have only reached 75% of it charge capacity during the time the fully charged battery bank was depleted. Electrical current is directed by the logic controller 40 to be drawn from the 75% charged battery bank until it reaches an approximate threshold of between 30% to 50% of its charge capacity. Meanwhile, the battery bank being charged only reaches about 60% of its charge capacity before the logic controller directs electrical current to be drawn from it and charging resumes on the previously depleted battery bank. Current will continue to be drawn from the battery bank with 60% charge capacity until it reaches an approximate threshold of between about 30% to 50% of its charge capacity. At this time, the logic controller will switch electrical current draw to the battery bank that was previously being charged, which only has time to reach between about 45% and 65% of its charge capacity. The charging of the power source 14 by these means should allow the electric vehicle to travel additional miles, increasing the total distance the electric vehicle may travel, but can not continue indefinitely as seen by the diminishing charge capacities that the battery banks reach. After a predetermined number switches between battery banks, in this example it would be 3 switches, the operator would know that the amount of reserve electrical current to power the vehicle is limited and they should return to an external power source for charging purposes.

The process of switching the electric current draw between a depleted battery bank to a charged battery bank and isolating which battery bank is charged may either be a manual or an automatic switching process. Whether the operator chooses an automatic or manual procedure, the same process of switching from a depleted battery bank to a charged battery bank, as described above, is followed. In the first instance, the logic controller 40 would indicate the need to switch between battery banks and follow the procedure described above for the operator. In a second instance, the logic controller 40 would indicate the need to switch between battery banks and the procedure of opening and closing the proper switches would be done by the operator manually. It should be noted that fully charged does not necessarily mean charged at 100% capacity.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An electrically powered vehicle, comprising:
a) a primary power source including first and second battery banks, each battery bank formed from a plurality of batteries connected to one another, each battery bank having a positive and negative terminal;
b) a motor connected to said power source through a controller, wherein said controller is connected to both negative terminals of said battery banks and said motor is connected to said positive terminal of said battery banks and said capacitor bank;
c) a power feedback system including a generator and at least one of a transformer and a power inverter, the generator being connected to the at least one of a transformer and power inverter and being adapted to condition current received from the at least one of a transformer and power inverter such that one of the battery banks of the primary power source is at least partially recharged an the other of the battery banks of the primary power source is providing current to the motor.

2. The vehicle of claim 1, wherein each battery bank in the primary the power source comprises two or more DC battery packs adapted to provide in total at least 48 V DC.

3. The vehicle of claim 2, further comprising a first and second drive motor/alternator set, the first drive motor/alternator set being electrically connected with the first battery bank, the second drive motor/alternator set being electrically connected with the second battery bank, wherein each of the drive motor/alternator sets include a DC drive motor configured to turn an alternator which provides AC current to the motor and wherein the motor utilizes the AC current to operate a transmission of the vehicle.

4. The vehicle of claim 3, wherein a capacitor bank is provided which comprises two or more capacitors adapted to be charged by at least one of the first and second drive motor/alternator set and wherein the capacitor bank is also adapted to provide power to the motor on an as-needed basis.

5. The vehicle of claim 1, wherein a switching mechanism is provided to alternate which of the first and second battery banks are recharged by the power feedback system.

6. The vehicle of claim 1, wherein a switching mechanism is provided to automatically switch which of the first and second battery banks are used to provide power to the motor.

7. The vehicle of claim 1, further comprising a pair of current limiting switches, each current limiting switch configured to limit the amount of current provided from the primary power source to the motor at any given point in time.

8. A method of operating an electric vehicle, comprising:
causing a first battery bank of a primary power source to provide electrical energy to a motor connected to a transmission;
while the first battery bank is providing electrical energy to the motor, causing a second battery bank of the primary power source to be at least partially recharged by a power feedback system, the power feedback system including a generator and at least one of a transformer and a power inverter, the generator being connected to the at least one of a transformer and power inverter and being adapted to condition current received from the at least one of a transformer and power inverter such that one of the battery banks of the primary power source is at least partially recharged an the other of the battery banks of the primary power source is providing current to the motor.

9. The method of claim 8, further comprising:
causing electrical energy from the first battery bank to also be provided to the power feedback system, wherein the electrical energy provided from the first battery bank is passed through the transformer to alter a voltage of the electrical energy.

10. The method of claim 8, further comprising:
providing an accessory power source which provides electrical energy to on-board electronics of the electric vehicle;
causing electrical energy to be provided to the power feedback system from the accessory power source, wherein the electrical energy provided from the accessory power source is passed through the power inverter to alter the electrical energy from DC current to AC current and wherein the generator comprises an AC generator.

11. The method of claim 8, wherein the generator receives electrical energy via both the transformer and the power inverter at substantially the same time.

12. An electrically powered vehicle, comprising:
a first DC battery bank electrically connected to a first DC motor, the first DC motor adapted to convert electrical energy from the first DC battery bank into mechanical energy for turning at least a first alternator;
a second DC battery bank electrically connected to a second DC motor, the second DC motor adapted to convert electrical energy from the second DC battery bank into mechanical energy for turning at least a second alternator;
the first alternator electrically connected to a drive motor;
the second alternator electrically connected to the drive motor, the drive motor adapted to convert electrical energy received from one or both of the first and second alternators into mechanical energy that is used to power a transmission of the vehicle; and
a power feedback system, the power feedback system including a generator and at least one transformer connected to the first and second alternators, wherein at least some supplemental energy not required to power the transmission is provided to the generator from one or both of the first and second alternators and is used to power the generator, which, in turn, recharged at least one of the first and second battery banks.

13. The vehicle of claim 12, further comprising an accessory power source which provides electrical energy to on-board electronics of the electric vehicle, wherein electrical energy from the accessory power source is also provided to the generator via a power inverter.

14. The vehicle of claim 12, further comprising a controller configured to automatically control which of the first and second DC battery banks are used to provide electrical energy to the drive motor at a point in time.

15. The vehicle of claim 14, wherein the controller is also adapted to control which of the first and second DC battery banks are recharged by the power generator of the power feedback system.

16. The vehicle of claim 12, wherein each battery bank comprises two or more DC battery packs adapted to provide in total at least 48 V DC to the first and second DC motor, respectively.

17. The vehicle of claim 12, wherein a capacitor bank is provided which comprises two or more capacitors adapted to be charged by at least one of the first and second alternators and wherein the capacitor bank is also adapted to provide power to the drive motor on an as-needed basis.

18. The vehicle of claim 12, wherein a switching mechanism is provided to alternate which of the first and second DC battery banks are recharged by the power feedback system.

19. The vehicle of claim 12, wherein a switching mechanism is provided to automatically switch which of the first and second alternators are used to provide power to the drive motor.

20. The vehicle of claim 12, further comprising a pair of current limiting switches, each current limiting switch configured to limit the amount of current provided from the first and second alternators to the drive motor at any given point in time.
